(19) United States
(12) Patent Application Publication
(10) Pub. No.: US 2003/0050825 A1
(43) Pub. Date: Mar. 13, 2003

(54) Computerized pharmaceutical sales representative performance analysis system and method of use

(75) Inventors: Gerald J. Gallivan, Naples, FL (US); Timothy A. Margraf, Medford, NJ (US); Gerhard K. Gallwitz, Haddonfield, NJ (US); Peter G. Bittinger, West Conshohocken, PA (US)

Correspondence Address: CAESAR, RIVISE, BERNSTEIN,, COHEN & POKOTILOW, LTD., 12TH FLOOR, SEVEN PENN CENTER, 1635 MARKET STREET, PHILADELPHIA, PA, 19103-2212, US

(73) Assignee: ImpactRx, Inc., Mt. Laurel, NJ

(21) Appl. No.: 09/947,034

(22) Filed: Sep. 5, 2001

(51) Int. Cl. G06F 17/60

(52) U.S. Cl. 705/10; 705/14

(57) ABSTRACT

A computerized system and method for conducting a survey of the promotional activities of sales representatives for specific pharmaceuticals of the various pharmaceutical companies. A single panel of physicians is provided to collect data regarding both (1) the promotional activities of the sales representatives whom they have encountered, and (2) the diagnosis and treatment of their patients. The data is provided into a database for analysis to evaluate any cause and effect relationship between the promotional activities of the sales representatives and the pharmaceuticals prescribed by them to their patients. of Montgomery, Commonwealth of Pennsylvania, respectively, have made a certain new and useful invention in a Computerized Pharmaceutical Sales Representative Performance Analysis System And Method Of Use of which the following is a specification.

### SPECIFICATION

### BACKGROUND OF THE INVENTION

This invention relates generally to analysis systems and more particularly to systems for analyzing the performance of pharmaceutical sales representatives.

Pharmaceutical companies market their products to physicians via in-house sales representatives or external sales organizations. In either case the sales representative, sometimes referred to as the “rep” or “detail” person, seeks to gain access to the physician to influence the treatment decision in favor of that rep's pharmaceutical company's drugs. Pharmaceutical companies devote a considerable amount of time to determining the effectiveness of their sales reps. This involves the collection and analysis of market research data regarding visits to dispensing physicians, et cetera. Many pharmaceutical companies conduct such market research activities in-house, while many also make use of outside, “data survey” providers to collect and analyze that information. Examples, of such outside firms are IMS Health, Inc. of Plymouth Meeting, Pa., Scott-Levin (a division of Quintiles Transnational, Inc.) of Newton, Pa. and Health Products Research (a division of Ventiv Health, Inc.) Of New York, N.Y. These data survey provider companies typically provide data collection and analysis services to the pharmaceutical industry on either a syndicated or a customized consulting basis. By syndicated it is meant that the companies collecting and analyzing the data regarding the promotional activities of the sales reps do so on an industry-wide basis and provide that information to any pharmaceutical manufacturer engaging their services.

The market research data collected heretofore has comprised data in the form of disease and treatment information and promotion activity information. In particular, the prior art typically recruits two panels of physicians across multi-disciplines to collect the data they require. There may be approximately 3500 or more physicians in each panel, with separate physician panels for the promotion data and the disease and treatment data. The audit of the physicians panels which has been accomplished in the past has been achieved by two types of methodologies. IMS Health, for example, has a panel of approximately 3,500 physicians, who are asked to provide information regarding the promotional activity of all of the reps that they meet every day. Scott Levin, on the other hand, uses a larger number of physicians for its panel, e.g., 7,000, however, collect less information from each physician than IMS Health. These physicians are asked to collect and record the promotional activity data one week a month. This information is recorded by the physicians of the panels on hard copy forms, sometimes called “diaries.” Among the promotional activity information that both companies have their panel of physicians collect is the company name, what products were “detailed,” the rating of the detail, the quality of the sales rep, e.g., poor, good, fair, et cetera, what product messages were provided by the representative, was the product compared to another product, safety, efficacy, et cetera. No data is collected regarding any tailored messages that the rep has been instructed to convey to the physician. In this regard, it is a common practice for pharmaceutical companies to have their reps deliver a specific or tailored message about each of their drugs to dispensing physicians, e.g., that this particular drug reduces fractures. This message is desired to be conveyed to the physician so that he/she will think of that concept when dealing with his/her patients who may need a drug for a specific treatment. In this example, the message about a specific drug reducing fractures would be one that a pharmaceutical company would want its reps to deliver to physicians who have a practice including many elderly persons. The prior art data collection does not collect information as to whether this tailored message was delivered to the physician, but rather collects generic information about the drugs, such as safety, efficacy, patient tolerance to the drug, etc.

A few of the survey provider companies also collect pharmacy-based data, that is data purchased from national pharmacy chains, regarding what drugs were dispensed. They integrate this data into their reports and attempt to determine cause and effect with the pharmacy generated data and the promotional data in the attempt to discern that a certain amount of promotional activity resulted in a certain amount of dispensed pharmaceuticals.

The prior art data survey companies use the filled-in paper forms received from their panels of physicians to enter that data manually into their databases and then to process that data for quality assurance and quality control. The data is compiled, analyzed and delivered to the pharmaceutical companies either in hard copy or electronically. For example, the hard copy may be in the form of monthly books, e.g., the “May 2001 Promotional Activities Information” and the “May 2001 Disease and Treatment Activities.” Among the information provided in these books or electronically are information regarding the various pharmaceutical companies, the various drugs of those companies, the number of times a sales representative or sales company has detailed the product to the physicians, et cetera. This information is broken out over time, with trends being indicated. The information is also broken out specially by company so that users of the report can compare company to company or product to product.

The prior art data survey providers also makes available to their pharmaceutical company clients data access tools that can be used with the electronically provided data to enable their clients to pick and choose the specific information that they want to see. For example, one typical query using such a data access tool would be to ask the system to compare one osteoarthritis drug against another osteoarthritis drug. These two drugs can then be analyzed with respect to each other with respect to market share, detailing level, promotional activities, counts, dollars, etc. Thus, the pharmaceutical company clients of the prior art data survey providers are able to get information about what their particular competitors are doing with respect to the detailing of the competing products. The pharmaceutical companies use this information to see if they can get a competitive advantage over their competitors.

Irrespective of which data survey provider company provides the data collection and analysis services, the physicians within their two panels do not cross over and provide information regarding the activities of the other panel. Thus, the physicians on the promotional panel do not provide any data regarding the diagnosis and treatment of their patient, they only collect and report data relating to the promotional activities of the reps who visit them. Conversely, the physicians on the disease and treatment panel do not provide any data regarding the promotional activities of the reps who visit them, they only collect and report on the diagnosis and treatment of their patients.

Since the data is provided with respect to either promotional activities or disease and treatment and are generated from two, separate and distinct, physician panels, which don't interact, the reports generated by the prior art are inherently incapable of drawing any accurate conclusions as to any correlation or causal link between the promotional activities of the reps and treatment of the patient, e.g., drugs prescribed. Collecting data regarding the drugs actually dispensed by the national pharmacy chains doesn't provide any meaningful insight into that causal link, since the drugs actually dispensed may not be the drugs prescribed by the physicians, e.g., a generic drug may be substituted, an insurance company may have required the substitution of one drug for another, etc. Thus, the prior art attempts to accurately link the pharmacy generated data with the promotional data to try to determine that a certain amount of promotional activity resulted in a certain amount of pharmaceuticals prescribed is doomed to failure.

Another drawback of the prior art data survey techniques for the pharmaceutical industry, is that heretofore no one has collected any information regarding the actual access of the reps to the physicians. Pharmaceutical companies collect data from their own reps themselves, as to the visits by the reps, but such data is not sufficiently specific as to whether or not the rep actually got past the front desk of the physician's office to speak to the physician. In this regard, most reps for the pharmaceutical companies are required to fill out sales call reports on their sales force automation tools. The pharmaceutical companies use this information in their analysis of the effectiveness of their promotional activities. However, these “call reports” are for the specific company for whom the rep works, and not for the industry as a whole. Thus, since the prior art companies providing the reports to the pharmaceutical companies do not collect access information, the only access information a pharmaceutical company will have will be the access information for its own reps, and not for those of its competitors.

As is known, many pharmaceutical companies have several companies or sales organizations represent them detailing the pharmaceutical company's products. In the past, the data gathered by the prior art was company-wide and not broken down by the specific representation groups doing the detailing. In short, the audits provided by the prior art do not capture any subset sales force activity, e.g., activity by various sales organizations representing a single pharmaceutical manufacturer. Heretofore this information has never been provided to pharmaceutical companies in a syndicated product. Data of this type might be provided by consultants to the pharmaceutical company's in the process of doing a personalized audit for such companies. However, even such customized audits are not industry-wide.

### SUMMARY OF THE INVENTION

This invention relates to a system and method for evaluating any causal linkage between the promotional activities of sales representatives for specific pharmaceuticals of the pharmaceutical industry and the pharmaceuticals prescribed by physicians for their patients. The method basically entails establishing a single panel of a plurality of geographically diversified prescribing physicians, e.g., high volume, general practitioners, family practitioners and internal medicine practitioners. First data is collected from each of these physicians regarding the promotional activities of the sales representatives whom the physicians have encountered with respect to the specific pharmaceuticals. Second data is collected from each of the physicians regarding the diagnosis and treatment of their patients with respect to the specific pharmaceuticals. The first and second data is provided into a database and the database of the first and second data is analyzed to evaluate any cause and effect relationship between the promotional activities of the sales representatives (including pharmaceutical company sponsored meetings and events) and the pharmaceuticals prescribed by the physicians to their patients.

In accordance with one exemplary aspect of this invention third data is also collected which relates to the access of the sales representatives to each of the physicians. This data is also provided into the database, e.g., to quantify the percentage of representatives for a specific pharmaceutical who gain access to the physicians. Moreover, data regarding the sales representative's encounter with the physician is also collected and entered in the database, e.g., to quantify the percentage of sales representatives for the specific pharmaceuticals who encounter the physicians. Among the data collected in the database is information regarding the nature of the encounter of the representative with the physician, e.g., if the encounter was a one-way conversation, a two-way conversation or a combination of a one-way and two-way conversation about a specific pharmaceutical or plural specific pharmaceuticals, if the encounter did not include any reference to any specific pharmaceuticals, and if a specific message about the pharmaceutical that is intended to be delivered by the sales representatives to the physician was, in fact, delivered to the physician.

In accordance with another exemplary aspect of this invention the database is provided with reference data including information regarding the specific pharmaceuticals, and which reference data is updated so as to be current.

In accordance with another exemplary aspect of this invention data is also collected representing the pharmaceutical company call record information and is provided into the database to discern true call activity and the correlation between self-reported call activity and physician reported encounter activity.

In accordance with another exemplary aspect of this invention data is also collected from the physician office staff regarding access of the sales representative to the physicians and from the pharmaceutical company's sample file records and such data is provided into the database to discern true physician office activity levels and the correlation between sample activity and physician office staff reported office activity.

In accordance with another exemplary aspect of this invention data is also collected representing pharmacy-level dispensed product prescription information and such data is provided into the database to provide a comparative analysis of the correlation between physician intended and pharmacy dispensed product prescription information.

In accordance with another exemplary aspect of this invention data is also collected representing patient-level disease treatment and managed care organization (M.O.) information and such information is provided into the database to provide a comparative analysis of the entire patient-provider-M.O. disease treatment continuum.

The system of this invention basically comprises a plurality of data entry devices (e.g., PDAs and laptop computers), a electronic communications network (e.g., the Internet and associated computer servers), and a computerized database (e.g., a software program resident on one or more computers/servers of the system). The plural data entry devices are arranged for use by respective ones of physicians of the single panel of physicians to collect the first and second data from each of them. Each of the data collection devices is arranged to be coupled to the electronic communications network to provide the data to the computerized database. The computerized database is arranged to be analyzed with respect to said first and second data to evaluate any cause and effect relationship between the promotional activities of the sales representatives and the pharmaceuticals prescribed by the physicians to their patients.

### DESCRIPTION OF THE DRAWING

FIG. 1 is a combination block/schematic diagram of a system constructed in accordance with one exemplary embodiment of this invention for carrying out one exemplary method of this invention;

FIG. 2 is a combination block/schematic diagram showing more details of the system shown in FIG. 1;

FIG. 3 is a block diagram of the details of the database forming a portion of the system of the subject invention;

FIG. 4 is a plan view of a hard-copy form used to collect data for use in the exemplary system shown in FIG. 1;

FIG. 5 is a front view of an exemplary data acquisition device, e.g., a PDA, used to collect data for use in the exemplary system shown in FIG. 1;

FIG. 6 is an illustration of various screens displayed by the data acquisition device shown in FIG. 5 to enable the collection of sales representatives visit data for use by the exemplary system shown in FIG. 1;

FIG. 7 is an illustration of various screens displayed by the data acquisition device shown in FIG. 5 to enable the collection of meetings and events data for use by the exemplary system shown in FIG. 1; and

FIG. 8 is an illustration of an exemplary screen displayed by a data acquisition device, e.g., a laptop or personal computer, to enable the collection of data for use by the exemplary system shown in FIG. 1.

### DETAILED DESCRIPTION OF THE PREFERRED EMBODIMENT

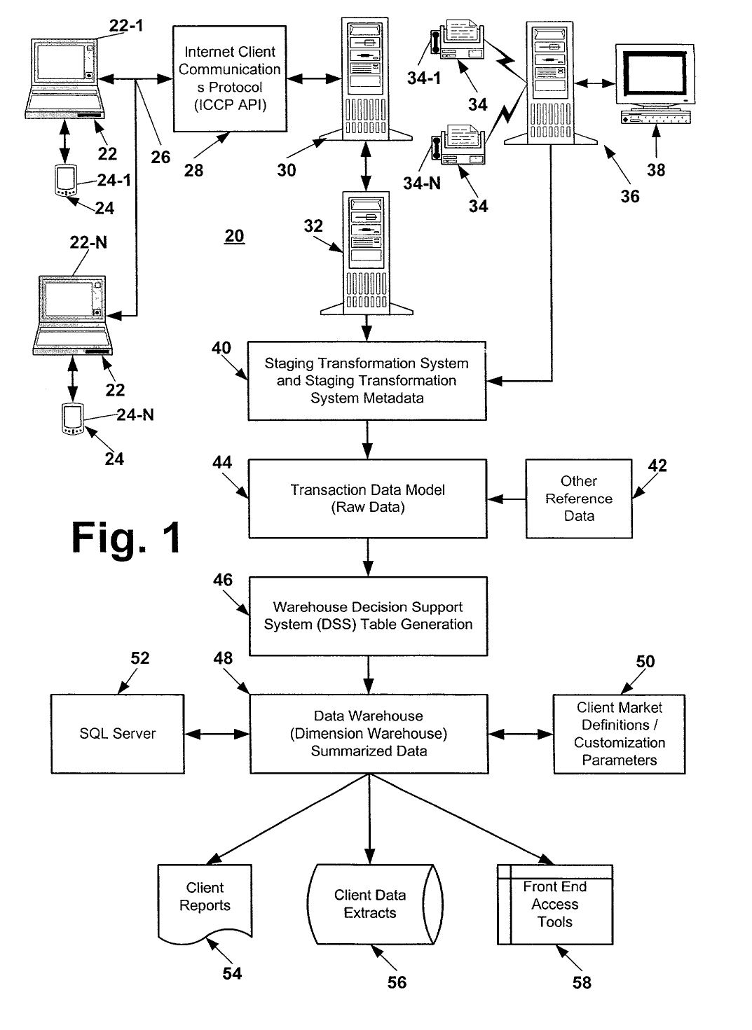

Referring to FIG. 1 there is shown at 20 in FIG. 1 a system for analyzing the performance of sales reps for pharmaceutical companies to determine their effect on pharmaceuticals prescribed for patients by the physicians that such reps engage. In accordance with one of the main aspects of this invention, the system 20 of this invention makes use of a single panel of prescribing physicians, e.g., at least 1000 general practice, family practice and internal medicine practice physicians, to collect the data. To facilitate the collection and capture of the data, each physician in the panel is given a laptop computer 22 and a personal digital assistant (PDA) 24. In FIG. 1 two lap-top computers 22-1 and 22-N and two PADs 24-1 and 24-N are shown. The lap-top computer 22-1 and the associated PDA 24-1 represent those input devices given to a first physician of the panel, whereas the lap-top computer 22-N and the associated PDA 24-N represent those input devices given to a Nth physician of the panel.

As will be described later, the physicians enter the data regarding promotional activities occurring at meetings or events outside their offices and data relating to the sales and promotional activities of the reps they encounter at their offices into their PDA. This information is then “hot-synched” or up-loaded into their lap-top computers 22. The data collected by the physicians relating to the diagnosis and treatment of their patients is entered directly into their laptops by the physicians. Each lap-top computer is arranged to be connected to an electronic communication network 26, in this case the Internet, to up-load the collected data into the system 20 and to download data and other information to the physicians' laptop computers 22. To achieve that end the system makes use of an Internet Client Communications Protocol or ICC API 28.

The raw data uploaded from the physicians via the Internet is collected on a Data Upload Server 30, hosted at some remote location and forming a portion of the system 20. The Internet Client Communication Protocol 28 provides a means to securely transmit information from the client data collection application the server 30 using a standard PPP communications session that runs over public networks (e.g., the Internet). The API for this protocol defines the methods by which the physicians communicate with the server. By using this API, the system 20 is able to eliminate all other forms of communication with the Web server 30, other that via this API, and greatly reduce the chances that the data or the server will be compromised in any way, despite their being exposed to the Internet.

The ICC API is broken down into six standard commands. These six ICC commands are invoked using the HTTP client “POST” mechanism, except for PITFALL, which uses the HTTP PUT method. The six commands are: LOGON (to log onto the server with a Username and Password), LOGOFF (to end the current login session), PING (to test connectivity between the physician and the server), PATRICK (to send a data record to the server for processing), GETFILE (to retrieve a named file from the server) and PITFALL (to transmit a file from the client to the server, via HTTP PUT). These six commands can accommodate the client-server communications needs of most applications. By versioning each command when it is transmitted, multiple versions of the ICC API can co-exist on the server, thus allowing a single server to host multiple, disparate applications, even if the applications support different, overlapping sets of commands. This API also enables the system 20 to leverage the public networks to communicate with its remote network of physicians. This communication includes the uploading of data input by the physicians to the system, and the downloading of new software versions to the physicians as the business changes. This electronic data collection results in unprecedented timeliness and quality of information regarding a physician's practice.

The web or Data Up-load Server 30 is connected, via any suitable electronic communications network, e.g., using FTP, to a Data Warehouse Server 32, located at another remote location and also forming a portion of the system 20. The Data Upload Server 30 and the Data Warehouse Server provide the data acquisition and processing for the system 20. In particular, the Data Warehouse Server 32 is where the relational database of the system resides. In one exemplary embodiment that database is Oracle-based and is updated nightly.

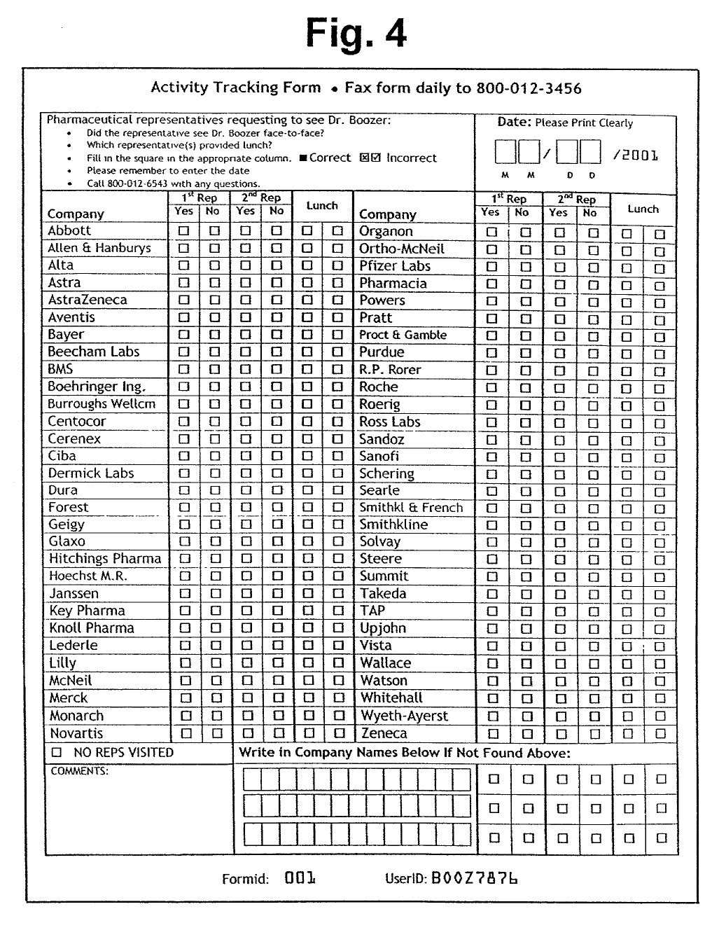

In this exemplary embodiment certain data, to be described in detail later and relating to the reps' access to the physicians of the panel, is collected by a designated person in the office staff of each physician of the panel. This data is collected manually by the designated person filling out a form, to be described later and shown in FIG. 4. That form is then sent by facsimile (FAX) from a facsimile machine 34 in the physician's office. In FIG. 1 two Fax machines 34-1 and 34-N are shown. These represent the fax machines of the first and Nth physicians, respectively, of the panel.

The fax data is collected by a Facsimile Server 36 located at some remote location and also forming a portion of the system 20. The faxed data is arranged to be processed to read it and to convert it to text files. This is accomplished by a OCR Forms Workstation computer 38 utilizing associated optical character recognition (OCR) software. The OCR Forms Workstation 38 is connected by a local area network to the Facsimile Server 36. The data from the two servers 32 and 36 is processed by a Staging Transformation System and Staging Transformation Metadata System portion 40 of the system 20 to transform the data into a normalized relational format and integrate it via standard processing keys.

The Staging Transformation System is a mechanism to use the Staging Transformation System Metadata to transform data between different data-models. These transformation processes can be adjusted to accommodate new business rules and new data simply by making adjustments to the metadata stored in the database. The transformation processing code reads the metadata from the database and processes the new data accordingly. The basic data processing algorithm used in the Staging Transformation System is: (1) load a row from the input staging table into the input record array, (2) perform input transformations on the input fields, (3) create and execute output record INSERT statements, composed of output fields that contain: (a) copies of transformed input fields, (b) constant values, (c) functional values (possibly using transformed input fields as parameters), and (d) macros, containing dynamic program values, and (4) repeat steps (1) through (3) for all remaining input records. Since a given input table row can source multiple output table rows, the processing in step (3) may occur multiple times for each input row loaded in step (1). The specific input and output processing that occurs in steps (2) and (3) is configured via the contents of the metadata tables. The rows in the various metadata tables are tied together for a particular processing run by a “job name.” The “job name” is an alphanumeric value that is stored in a column that appears in all tables in the metadata. The job name is passed to the Staging Transformation program on the command line.

In addition to the metadata, some environment-specific information is specified via a “configuration file.” These configuration parameters tend to be specific to a particular machine or database installation, while the information stored in the metadata is specific to a particular processing job (i.e., the input and output table formats).

The Staging Transformation System and Staging Transformation Metadata System enables the system 20 to maintain a highly flexible data maintenance environment, and react quickly to changes in business rules and data input variables. These changes can flow throughout the entire system relational processing stream, with minimal or no code changes to the system processing. Only the metadata in the tables is changed, and the new fields or business rules will be handled by the processing logic via the Staging Transformation System in a seamless manner.

The output from the portion 40 of the system 20 is normalized transaction records, created from de-normalized staging records. That output, along with Other Reference Data 42, is provided to the Transaction Data Model (Raw Data) portion 44 of the system 20. The data provided by the Other Reference Data is any data that the system makes use of to keep it current and accurate, e.g., update information about the various pharmaceuticals the system is arranged to evaluate, update information about the diagnoses (ICD9), and list of values for the application picklists (to be described later), etc. The Transaction Data Model (Raw Data) portion 44 of the system is arranged to represent the collected data in a normalized format for access and analysis. The output from the Transaction Data Model (Raw Data) portion 44 is transformed into a decision support star schema model, and is provided to the Warehouse Decision Support System (DSS) Table Generation portion 46 of the system 20. The portion 46 of the system 20 is arranged to facilitate reporting and analysis of the information. To that end, the output from the Warehouse Decision Support System (DSS) Table Generation 46 is a set of summarized fact and dimension tables, and is provided to another portion of the system 20, namely, the Data Warehouse (Dimension Warehouse) Summarized Data portion 48. The portion 48 is arranged to create final client deliverables (to be described later). To that end, the Warehouse (Dimension Warehouse) Summarized Data portion 48 is coupled to a portion 50 of the system called the Client Market Definitions/Customization parameters. The portion 50 is arranged to provide customized views of the data to clients. The Warehouse (Dimension Warehouse) Summarized Data portion 48 is also coupled to a SQL Server 52. The SQL Server 52 stores the database of physician information, e.g., name, address, and office and practice details. The SQL Server 52 is arranged to support the Customer Relationship Application (to be described later) for the physicians. The output of the Warehouse (Dimension Warehouse) Summarized Data portion 48 serves as the “deliverables” of the system 20, i.e., the information delivered to the various pharmaceutical company clients of the provider of the system 20. These outputs are in the form of Reports 54, Client Data Extracts 56 and Front End Access Tools 58. The Reports 54 are provided to the client in two manners. One manner is electronically and such reports consist of flat files and on-line documents. The other manner of document or report delivery is in hard copy format. A discussion of the contents of these reports will be set forth in detail later.

The Client Data Extracts 56 basically comprise detailed analysis of the information that has been customized using the Client Market Definitions/Customization portion 50 and are provided to the client in electronic and/or hard copy form.

Some clients may wish to be able to extract various information from the reports in a customized manner. To that end, such clients are provided with the Front End Access Tools 58. These tools basically comprise a way for the client to create their own reports and views of the data.

While not shown, the system 20 also includes a Customer Relationship Management (CRM) subsystem that allows the system 20 to track, monitor, and report on all interactions with the physician panel. The CRM subsystem includes a call center for receiving telephone calls from the physicians of the panel. In particular, each time a physician calls in to the system's call center, the call is recorded, and call history is displayed to enhance the interaction with the physician. This system also interacts with other portions of the system 20 by taking feeds of data from the data warehouse, so a physician's data upload history is known at the time of the call.

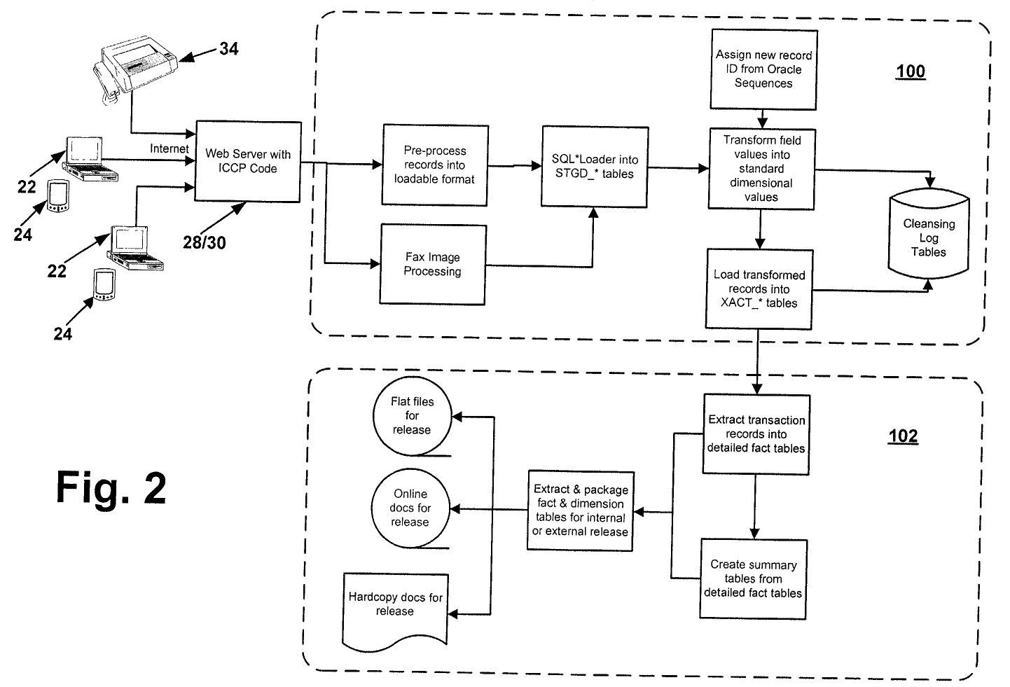

Turning now to FIG. 2 more details of the system 20 will now be described. To that end the functional operation of the database/application server portion of the system 20 is shown within the broken line box designated by the reference number 100, while the warehouse design support system (DSS) table generation portion of the system is shown within the broken line designated by the reference number 102. Thus, as can be seen the data from the web server with the ICC code is provided to the system portion 100 for processing of the raw text data uploaded by physicians into a relational table that contains the verbatim format. This data is parsed into fields using delimiters provided by the software. Once the data is loaded into the staging tables, it is then run through the record formatter, and using the processing metadata, is transformed into normalized tables to populate the transaction model. The output of the system portion 100 basically comprises the transaction tables and is provided to the system portion 102. That portion is arranged for processing into a star schema model to be used for analysis and reporting. The key metrics are transformed into dimensions and the non-key metrics are transformed into attributes. The reporting metrics are transformed into counts, and summed up into summary tables.

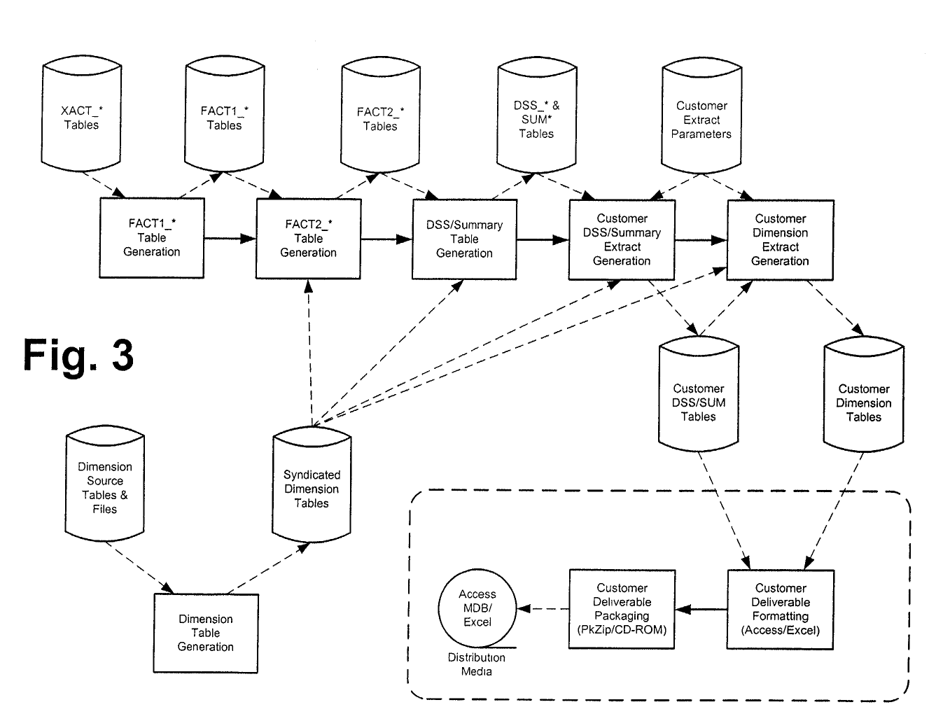

Turning now to FIG. 3 the details of the system's warehouse design support system (DSS) table generation portion 102 will now be described. To that end the warehouse model supports client specific extracts that are customized using the client's market definitions, and sub-setted into the segments of data that the client has purchased. The extract is packaged into deliverables using calculations, such as “share” (product share within a defined market definition, such as cholesterol lowering drugs) and “trending” (reporting information over time).

As can be seen in FIG. 3, the tables in the warehouse model are broken down into three main areas: fact tables, syndicated dimension tables, and customer specific dimension tables. The fact tables contain the business metrics that are to be reported on, such as the physician-intended prescriptions (to be described in detail later and referred to by the trademark metric IRx) and the physician-sales rep encounters (also to be described later). The fact tables can either be at the most granular level (base fact) or summarized to a higher level based on the hierarchy in one of the dimensions. The syndicated dimension tables contain all the possible values of a dimension, such as product, as well as the roll-up structures for that dimension, denormalized into a single table. An example of the roll-up structures for the product dimension is form strength to brand to therapeutic class.

The customer specific dimension tables contain the custom roll-up structures for particular dimensions that make the information meaningful to the client. An example of these roll-up structures is a set of products that comprise a market the way the client wants to view that market. The last type of customer specific dimension table is the extract parameters table. This defines the periodicity and dimension values that are to be provided to a given client for a given deliverable.

These dimension and fact tables together make up the warehouse model that supports a table driven, metadata based, flexible decision support environment for customizable client deliverables.

The type of data collected by the system of this invention and its manner of collection will now be considered. To that end the system of this invention collects more detailed, specific and relevant data than that collected by the prior art regarding the reps who visit the physicians. For example, as mentioned earlier the system 20 makes use of printed forms which is filled out for each rep who visits the office to capture data about that visit. This form used is called the “Activity Tracking Form” and an exemplary form is shown in FIG. 4. As can be seen therein the Activity Tracking Form comprises a table of the various pharmaceutical companies organized in horizontal rows and plural, e.g., two, columns for collecting information about the reps for each of those pharmaceutical companies who visit the office. The two rep columns are designated as “1^{st} Rep” and “2^{nd} Rep. Each of these columns is broken down into two sub-columns, “Yes” and “No,” with check boxes in each sub-column. The form is filled out for a particular rep of a particular company to indicate whether that rep actually saw the physician face-to-face by checking the appropriate “Yes” or “No” box. The form also includes a column designated “Lunch” with two sub-columns including respective check boxes to indicate whether or not the rep provided lunch. As can be seen the form includes other areas for collecting additional information, e.g., the date, etc. The form accommodates information about plural reps for each company, since more than one representative for a pharmaceutical company may visit the physician's office on a given day. Each visit by a rep for that particular company is noted on the form. This form is filled out by a designated person at the front desk of the physician's office. The complete form is then faxed daily to the Server 36, whereupon the form is scanned and OCR'ed to produce text files for daily uploading to the Data Warehouse Server for inclusion in the Staging Transformation System. If desired, the information from the received faxed form may be manually entered, e.g., keyed into the database, by personnel of the system provider.

As will be appreciated by those skilled in the art, those reps who get past the front desk don't necessarily get to have a face-to-face discussion with the physician, e.g., they may only gain access to the physician's drug sample storeroom to provide samples to the office, they may only pass the physician in a hall, etc. Thus, the Activity Tracking Form also captures data regarding competitive access along with the previously described competitive visit activity. Among the information provided to the pharmaceutical company clients of the system provider resulting from the collection and analysis of the data regarding competitive access is a metric, to be described in detail later, designated by the trademark “ACCESS RATING” by the assignee of this invention, ImpactRx, Inc. of Mt. Laurel, N.J. This rating represents the percentage of reps gaining access. Both of these pieces of information, that is, the visit and access are captured by the single Activity Tracking Form. Use of the commercial embodiment of this invention by the assignee has revealed that in typical cases approximately 65% of the reps that visit the office get beyond the front desk/waiting room of the physician, i.e., the reps have an ACCESS RATING of 65%.

The system 20 collects data from the physicians in the panel regarding their encounter with the sale reps to provide another metric or data piece, which is designated by the trademark “ENCOUNTER RATING” by the assignee of this invention. This metric represents the time that the rep actually has a personal encounter with the physician, whereas the ACCESS RATING metric indicates only that the rep has gotten beyond the front desk. The ENCOUNTER RATING metric represents any meetings with the physician. As mentioned earlier, on a industry-wide basis an ACCESS RATING of 65% has been determined. Insofar as those reps actually encountering or speaking to the physicians, it has been determined that on an industry-wide basis approximately 45% of those reps getting past the front desk actually encounter or speak to the physician, i.e., the ENCOUNTER RATING is 45%.

Another metric measured by the system of this invention is the “quality” of the encounter. The quality measurement is broken down into three categories or metrics. The first of those categories is where no pharmaceutical product is discussed. This type of encounter conversation between the sales rep and the physician may be small talk or chit-chat or about matters other than the products of the pharmaceutical company represented by the rep. The data regarding this metric is collected by the physician on his/her PDA (as will be described later) in a data field called “No Product Discussed.” It has been determined that of the 45% of the reps who have an encounter with the physician, fully 10% of those persons never discuss the pharmaceutical products with the physician, but rather discuss other things or merely exchange pleasantries.

The next of the three categories or metrics for quality is the so-called “One Way Discussion.” In this type of encounter the representative merely makes some statements about the pharmaceutical company's product, but gets no response from the physician. This could occur in the case where the rep merely passes the physician in the hall and says “Dr. Smith, don't forget when you have patients with high cholesterol to prescribe XYZ since it is very effective for your high LDL patients.” The data regarding this category or metric is collected by the physician in a data field called “One Way Discussion.” It has been determined that of the quality encounters, roughly 40% of such encounters are of a One Way Discussion.

The last of the three categories or metrics for quality is the so-called “Two Way Discussion.” In this encounter the rep gives the physician information regarding the pharmaceutical company's product(s) and the physician engages that rep in a conversation about that product(s). It has been determined that such two-way conversations occur approximately 40% of the time.

The subject invention may also collect data from the physician's on another type of encounter, namely, a combination of the one-way and two-way encounters. For example, in a combination encounter the rep may actually engage the physician in a discussion about one of the pharmaceutical company's products, where that conversation is a true two-way conversation, but then merely may present certain information about other of that pharmaceutical company's products to the physician but not engage the physician in any dialog regarding those other products. This is then the combination encounter. It has been determined that the combination of encounter occurs approximately 10% of the time.

Another metric used by the subject invention and captured by the physician on his/her PDA is designated as the “Message” metric. This metric is designed to indicate that the rep has delivered a desired information or message that the pharmaceutical company wants delivered to the physician, e.g., telling the physician that a particular drug requires only once daily dosing, has the benefit of reducing fractures, etc. It is the particular message delivered that ultimately has a major effect in driving the physician to prescribe a specific pharmaceutical company product. The subject invention captures the message or messages delivered by the reps. This should be contrasted with the prior art, wherein the messages collected typically have involved messages about safety, efficacy and dosage information and not the on-target messages which the sales reps are instructed to deliver to the physicians.,

The system 20 also captures, via the physicians, data regarding sales and promotional activities occurring at meetings or events. This meeting and event data entails encounters between the reps and the physicians occurring outside the office, such as at medical meetings and at social or professional events. Examples of such meetings and events are pharmaceutical company sponsored symposiums, etc.

Thus, as should be appreciated from the foregoing the subject invention enables the physicians of the panel to collect and capture data involving the activities of the sales reps for “details” occurring at either the physician's office, a hospital, clinic, nursing home, by telephone or by an Internet communication (sometimes referred to as a “eDetail’). This type of data can be referred to as the “Sales Rep Application.” In order to enable the physician to readily capture the Sale Rep Application, the PDA 24 provided to each physician includes software in it displaying various screens and fields for the physician to enter data regarding the various metrics measured. The data is entered into the PDA hot synched to the physician's laptop 22 and then periodically uploaded to system, e.g., uploaded five days per week. As will be described later the physician also captures diagnosis and treatment data for his/her patients. That data is entered directly into the physician's laptop computer 22 and uploaded to the system two days per week.

The various fields of information collected in the Sales Rep Application is shown in the following Table 1. In that table each of the various fields, e.g., is listed in the first column. For example, one of the fields is the date of the encounter or visit by the rep, designated by the field label “Visit Date” appearing in the first column. The description of the type of information for this field is listed in the last column. In this example, the Visit Date field is for data representing the date of the sales rep's visit. It is the date that the physician actually saw the sales rep, not the date that the record was entered or the date the record was uploaded. As can be seen from Table 1, some fields of data are required, by that it is meant they must be filled in by the physician, while others are optional. Thus, entry of a specific field's data is required in the Table's column next to the field name or label the word “Yes” will appear. The actual data that can be entered, for each field is designated in the Table 1 by the column bearing the heading “Possible Values.” Thus, for example, with respect to the Visit Date field, the physician can enter a valid date that is not in the future from the current date. The physician's PDA will default to the date the PDA is used to enter the data (as will be discussed in an example to follow), but the physician should over-ride that date if it is not the actual date he/she met with the rep. In Table 1 the values that are shown within quotation marks represent the choices of predetermined values that can be selected by the physician. For example, insofar as “Time Spent With Rep” is concerned the physician can select from either “<1 min,”” “1-3 min,” “3-5 min,” “5-10 min,” and “>10 min.”

TABLE 1
Sales Rep Application

| Field | Required | Possible Values | Description |
|---|---|---|---|
| Visit Date | Yes | A valid date that is not in | This is the date of the sales rep's visit. It is |
| | | the future from the current | the date the physician actually saw the sales |
| | | date | rep, not the date the record was entered, or |
| | | | the date the record was uploaded. |
| Company | Yes | From a picklist of | This is the name of the company of the |
| | | manufacturers/ | sales rep that is detailing the physician. |
| | | companies/sales forces | |
| Location of Detail | Yes | office, hospital, clinic, | This is the location where the encounter or |
| | | nursing home, phone, | detail was performed by the sales rep. |
| | | eDetail (Internet) | |
| Product Discussion | Yes | “<1 min,” “1-3 min,” “3-5 | This choice indicates if the sales rep |
| | | min,” “5-10 min,” and “>10 | discussed a product with the physician or |
| | | min” | not. |
| Time Spent with | Yes | | This is the amount of time the rep spent with |
| Rep | | | the physician during the encounter. |
| Product Detail | No | Only required if “Product | Up to four products detailed during the |
| 1, 2, 3, 4 | | Discussion” is selected | encounter. |
| Product | Yes | From a picklist of | The product that the sales rep discusses |
| | | products that the system | with the physician for the given detail |
| | | creates as brands that are | |
| | | promoted. | |
| One Way/Two | Yes | “One way” or “Two way” | This choice indicates whether the discussion |
| Way | | | for the given detail was a one way (only rep |
| | | | talks) or two way (a discussion where the |
| | | | physician asked questions or commented on |
| | | | the product). |
| Compared To | No | From a picklist of | The competitive product that the sales rep |
| | | products that the system | compared to the detailed product (if any). |
| | | creates as brands that are | |
| | | promoted. | |
| Sales Aid | Yes | “Electronic,” “Paper,” | The type of sales Aid used in the product |
| | | “Clinical Study,” “None” | discussion for the given encounter |
| Messages/Custom | Yes (at least | 14 standard messages or | These are the messages that the rep used |
| Messages | one) | up to 9 custom messages | in the product discussion to promote the |
| | | + 2 defaults | product that was discusses. These |
| | | | messages can either be from a standard set, |
| | | | or can be customized for a given product. |
| Message | No | Free Form Text (up to 256 | This is a space where the physician can |
| | | characters) | write any notes they want to regarding the |
| | | | product discussion |

Another type of data collected by the physicians of the panel involves any promotional activities directed to physicians at meetings and events attended by the physicians. This type of data is referred to as the “Meetings and Events Application” and is also input into the PDA by the physicians of the panel using various input screens. An example of such data entry will also be given later. The various fields of information collected in the Meetings and Events Application is shown in the following Table 2. Table 2 is similar to Table 1 in its organization. Thus, the field name or labels for various fields are listed in the first column. For example, one of the fields is the “Meeting Event Date.” The description of the type of information for this field is listed in the last column, e.g., “This is the date of the meeting/event. It is the date the physician actually attended the meeting/event, not the date the record was entered, or the date the record was uploaded.” Like Table 1, Table 2 has some fields which require data entry and some which are optional. So too, the actual data that can be entered, for each field is designated in the Table 2 by the column bearing the heading “Possible Values.” Thus, for example, with respect to the “Location of Event” field, the physician can select from one of the following choices “Entertainment Venue,” “Hospital,” “In Office,” “Internet,” “Phone,” “Restaurant,” “Weekend Symposium,” and “Other.”

TABLE 2
Meetings and Events Application

| Field | Required | Possible Values | Description |
|---|---|---|---|
| Meeting Event Date | Yes | A valid date that is not in | This is the date of the meeting/event. It is |
| | | the future from the current | the date the physician actually attended the |
| | | date | meeting/event, not the date the record was |
| | | | entered, or the date the record was |
| | | | uploaded. |
| Sponsor | Yes | From picklist of | This is the company that is sponsoring the |
| | | manufacturers/ | event. |
| | | companies/sales forces | |
| Location of Event | Yes | “Entertainment Venue,” | This is the location where the event was |
| | | “Hospital,” “In Office,” | held. |
| | | “Internet,” “Phone,” | |
| | | “Restaurant,” “Weekend | |
| | | Symposium,” “Other” | |
| Topic | Yes | Freeform text | The physician enters the topic of the |
| | | | meeting. |
| Topic Quality | Yes | 1 to 7 | The quality of the topic as perceived by the |
| | | | attending physician. 1 is low and 7 is high. |
| Location Quality | Yes | “Excellent,” “Very Good,” | The quality of the location as perceived by |
| | | “Good,” “Fair,” “Poor” | the physician. |
| Product | No | From a picklist of | The product that was discussed at the |
| | | products that the system | meeting (if any). |
| | | creates as brands that are | |
| | | promoted | |
| Nature | Yes | “No Product Discussed,” | The nature of the meeting as described by |
| | | “Investigational Drug,” | the choices at left. |
| | | “Product Specific” | |
| Program Length | Yes | “<30 Min,” “31 Min-1 | The length of the program. |
| | | hour,” “1-2 hours,” “2-4 | |
| | | hours,” “>4 hours,” | |
| | | “overnight” | |
| Speaker | No | Freeform Text | The name of the speaker |
| Speaker Info | No | “Local Specialist,” | The type of speaker |
| | | “Regional Thought | |
| | | Leader,” “National | |
| | | Thought Leader” | |
| Attendee Count | Yes | 1 to 99999 | The number of attendees at the meeting |
| CME Credits | No | Yes or no | Indicates whether the physician is able to |
| Offered | | | earn CME credits at the meeting. |

The last type of data collected by the physicians of the panel is the data relating to the diagnosis and treatment of their patients to be correlated to the promotional activities of the reps. This type of data is referred to as the “Patient Application” and is also input into either the PDA or laptop by the physicians of the panel using various input screens on the PDA and/or laptop. Examples of such data entry will also be given later. The various fields of information collected in the Patient Application is shown in the following Table 3. Table 3 is similar to Tables 1 and 2 in its organization. Thus, the field name or labels for various fields are listed in the first column. For example, one of the fields is the “Visit Date.” The description of the type of information for this field is listed in the last column, e.g., “This is the date of the patient visit. It is the date the physician actually saw the patient, not the date the record was entered, or the date the record was uploaded.” Like Table 1, Table 2 has some fields which require data entry and some which are optional. So too, the actual data that can be entered, for each field is designated in the Table 2 by the column bearing the heading “Possible Values.” Thus, for example, with respect to the “Insurance” field, the physician can select from one of the following choices “Cash,” “HMO/PPO/POS,” “Indemnity,” “Medicaid,” “Medicare,” “None,” and “Not Known.”

TABLE 3
Patient Application

| Field | Required | Possible Values | Description |
|---|---|---|---|
| Visit Date | Yes | GT 1/1/2001 and less | This is the date of the patient visit. It is the |
| | | than current date. The | date the physician actually saw the patient, |
| | | exception is that 1/1/2000 | not the date the record was entered, or the |
| | | is allowed for test upload | date the record was uploaded. |
| | | records | |
| Age | Yes | 0 to 119 | This is the age in years of the patient. |
| | | | Physicians can enter 0 as the age for infants |
| | | | less than 1 year old. |
| Gender | Yes | M or F | The gender of the patient |
| Insurance | Yes | “Cash,” “HMO/PPO/POS,” | This is the type of insurance the patient has. |
| | | “Indemnity,” “Medicaid,” | |
| | | “Medicare,” “None,” “Not | |
| | | Known” | |
| Location | Yes | “Clinic,” “Hospital,” | This is the location the physician saw the |
| | | “Nursing Home,” “Office,” | patient. |
| | | “Other,” “Phone” | |
| Diagnosis (1, 2 or 3) | Yes | From Diagnosis List | This is the Diagnosis of the patients illness. |
| Diagnosis Type | Yes | “Newly Diagnosed,” | This is the type of diagnosis for the patient's |
| | | “Previously Diagnosed” | illness. If a physician has previously seen a |
| | | | patient for a given condition, he/she will |
| | | | check “Previously diagnosed.” Otherwise |
| | | | the physician will check “Newly Diagnosed.” |
| Severity | Yes | “Mild,” “Moderate,” | This is the severity of the patients diagnosis. |
| | | “Severe” | |
| Non Drug Treatment | No | “Diet,” “Rest,” “Exercise,” | This is the type of non drug treatment the |
| | | “Alternative,” “Other” | physician has given to the patient for the |
| | | | given diagnosis. |
| Patient Requested | Yes (yes or | From picklist of all drugs | This is the drug that the patient requested |
| Drug | no required) | tracked by the system | for the given diagnosis (if any) |
| Rx1, Rx2, Rx3 | No | Not required (well visit) | The following fields are part of the |
| | | | prescription (Rx) information for a given |
| | | | diagnosis. |
| Product name | Yes | From picklist of all drugs | The name of the product the physician |
| | | tracked by the system | prescribed for the given diagnosis. |
| Form Strength | Yes | From picklist of | The form/strength for the given Rx. |
| | | form/strengths for the | |
| | | given drug | |
| Rx, Rx with Sample, | Yes | One of the 3 must be | This allows a physician to indicate whether |
| Sample Only | | checked | there was a sample provided with the Rx, or |
| | | | whether a sample and no Rx was given. |
| Dispensed | Yes | 1 to 999 | The quantity dispensed for the given Rx. |
| Schedule | Yes | “1 per week,” “1 per | The schedule that the patient will take the |
| | | month,” “BID,” “QD,” | given Rx. |
| | | “QID,” “TID,” “PRN,” | |
| | | “Q6H,” “Q8H,” “Other” | |
| Refills | No | 1 to 999 | The number of refills for the given Rx. |
| Change | | | |

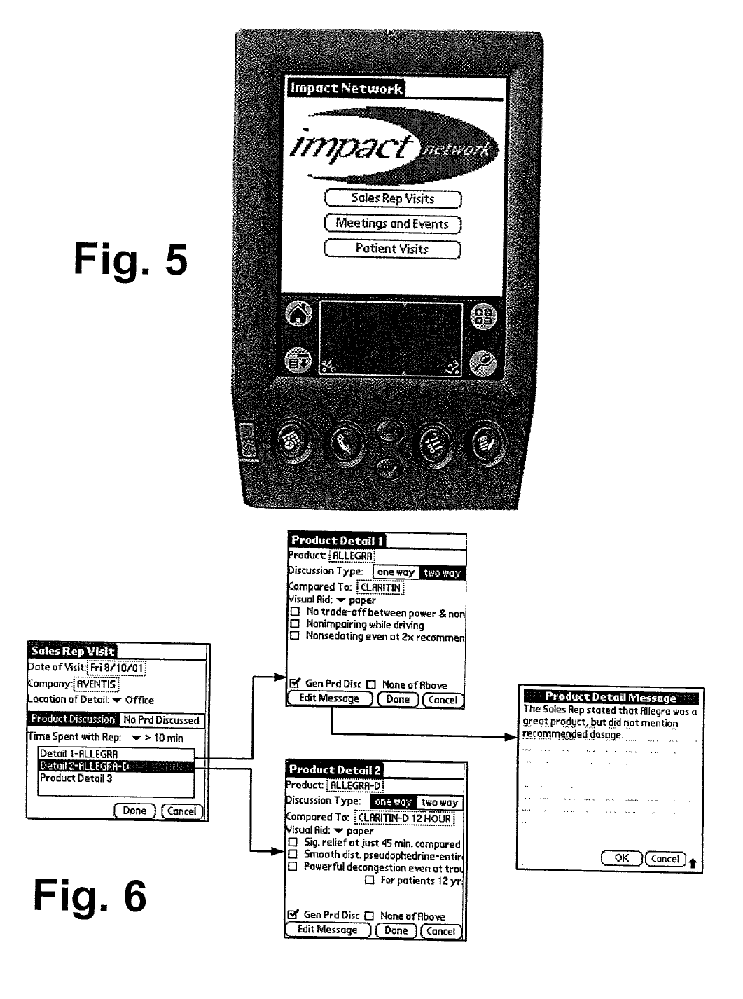

The following is are examples of the entry of Sales Rep Application data by the physician into his/her PDA 24, as shown in FIGS. 5-7. In the first of these example it is assumed that the physician is entering information regarding his/her encounter with a sales representative of a pharmaceutical company at his/her office. Thus, as can be seen in FIG. 5, the physician has to select one of two buttons appearing on the first screen of his/her PDA, namely, either the “Sales Rep Visits” button or the “Meetings and Events” button. Since this example is for an office visit, the “Sales Rep Visits” button is actuated to automatically bring up the first screen of the Sales Rep Visit module. That screen is shown as the left-most screen in FIG. 6. The date of the encounter or visit is entered automatically by the PDA's internal clock and is displayed on the PDA's screen in the box entitled “Date of Visit” unless the physician did not meet with the rep on that date. If that is the case the physician enters the actual date of the encounter with the rep (as defined in Table 1 above). The physician next has to select the identity of the pharmaceutical company that the rep represents. This is accomplished by clicking on the box next to the word “Company” on the PDA screen, whereupon a drop down or pick list of the various pharmaceutical companies is displayed. The physician clicks on the appropriate company and that company's name now appears in the box. In this example, it shall be assumed that the company for whom the rep is detailing is Aventis. Alternatively, the name of the company can be manually entered in the box. The next item of information to be entered is the location of the encounter. This is accomplished by the physician clicking on the drop-down or pick-list arrowhead next to the words “Location of Detail.” In the example shown the physician has selected “Office” since that is where this exemplary encounter has occurred. If no product was discussed the physician enters this information by clicking on the box bearing the words “No Prd Discussed.” If, however, a product is discussed the physician enters this information by clicking on the box bearing the words “Product Discussion.” In this case a product was discussed so that the box with the words Product Discussion is highlighted. The time spent for this encounter is entered by the physician clicking on the drop down list arrowhead next to the words “Time Spent with Rep:.” In the example shown the physician has selected “>10 min.”

The selection of the pharmaceutical(s) discussed is then recorded by the physician clicking on any of the terms “Product Detail 1,” “Product Detail 2,” or “Product Detail 3” appearing in a large box below the “Time Spent With Rep” field. In the example shown the physician has already entered information about a first product discussed, namely, Allegra, and that information has been recorded in the PDA as “Detail 1.” The product discussed in the second discussion, i.e., the product discussed in this example, is Allegra-D and that is entered by the physician clicking on “Product Detail 2,” whereupon a pick—list of “Aventis” products is displayed, from which the physician selects the one discussed, e.g., Allegra-D. This selection is then displayed as “Detail 2- ALLEGRA-D.”

Once the physician has completed this screen he/she clicks on the “Done” button to enter the data into the PDA's memory. This action brings up the next screen to enable the entry of information about the encounter with respect to the second of the “detailed” drugs, in this case, ALLEGRA-D. This screen is shown as the bottom-most of the middle two screens shown in FIG. 6. The uppermost of the middle two screens of this figures shows the information previously entered by the physician for the first detailed drug, namely, ALLEGRA. With respect to the second detailed drug, the screen displays the name of the drug ALLEGRA-D next to the word “Product.”

The physician then enters information regarding the quality of the encounter, e.g., whether it entailed a one-way discussion (the rep speaking about the drug, but not engaging the physician in a dialog about the drug) or a two-way discussion (a dialog between the rep and the physician about the drug). In this example the encounter regarding ALLEGRA-D was a one way discussion. Next the physician enters information about any competitive drugs that may have been discussed by clicking on the box next to the word “Compared To” on the PDA's screen. This action cause a pick-list of the various competitive drugs to ALLEGRA-D to be displayed on the screen. The physician clicks on the appropriate drug and that drug's name now appears in the box. In this example the physician selected “CLARITIN-D 12 HOUR.” The physician then enters information regarding any visual aids that were used, by selecting the appropriate data from a pick-list next to the words “Visual Aid.” In this case a visual aid paper was used.

The physician then enters additional information regarding the encounter in the nature of the type of message delivered by the rep. As mentioned above, each pharmaceutical company has some specific message or messages that it wants its reps to convey about each of its drugs. This data is contained in the system's database and is loaded into the PDA where it resides when the physician hot synchs his/her PDA. Thus, the system can update the messages desired to be communicated about each product to the physicians so that they can determine if the sales reps have conveyed those messages to them. In the example shown there are three tailored messages desired to be conveyed, about ALLEGRA-D. Each of these tailored messages is displayed on the PDA screen with a check box next to it. Accordingly, the physician can check off each message conveyed to him/her by the rep to indicate that the desired message was delivered. In this example none of the boxes is checked. Instead the physician has checked the box bearing the words “Gen Prd Disc.” located below the tailored message boxes. This indicates that the discussion about ALLEGRA-D was a general product discussion. There is also a check box bearing the words “None of Above” which is provided for the physician to check if the encounter didn't entail any discussion of tailored messages or a general product discussion. Below those check boxes is a button bearing the words “Edit Message.” This is provided to enable the physician to click on it to open a window into which he/she can enter any information he/she cares to make about the encounter. In this example, the physician did not select the Edit Message button for Product Detail 2. Thus, once this screen is completed, the physician clicks on the button bearing the word “Done” to enter that data into the PDA's memory for subsequent uploading to the system. In the example of FIG. 6, it can be seen that the physician had selected the “Edit Message” button on the Product Detail 1 screen to open the Product Detail Message screen as shown in the right-most screen in FIG. 6. In this example, the physician entered “The Sales Rep stated that Allegra was a great product, but did not mention recommended dosage.”

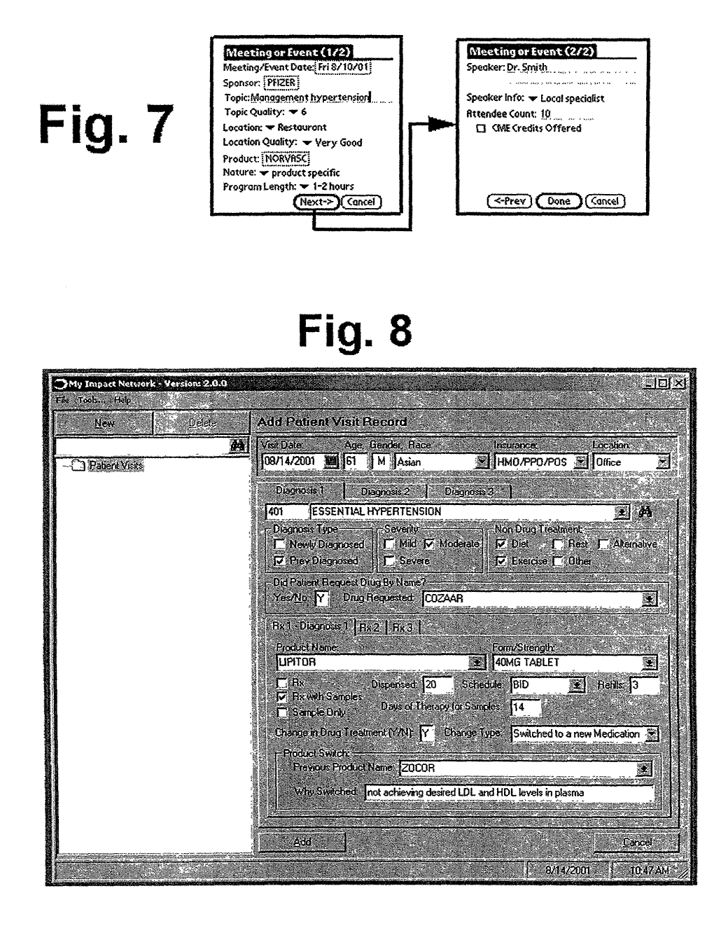

In FIG. 7 there is shown the PDA that a physician has entered information about a meeting or event. Thus, as can be seen, the first screen selected by the physician to enter this information, i.e., the left-most of the two screens in FIG. 7, displays the heading “Meeting or Event (½).” Below that heading there is a box for the entry of the date of the meeting or event. The date of the is entered automatically by the PDA's internal clock and is displayed on the PDA's screen in the box entitled “Meeting/Event Date.” The physician can enter a different date, if that date is not the actual date of the meeting or event being recorded. If that is the case the physician enters the actual date of the meeting or event (as defined in Table 2 above). The physician next has to select the identity of the pharmaceutical company that sponsored the meeting or event. This is accomplished by clicking on the box next to the word “Sponsor” on the PDA screen, whereupon a drop down or pick list of the various pharmaceutical companies is displayed. The physician clicks on the appropriate company and that company's name now appears in the box. In this example, it shall be assumed that the sponsoring company is Pfizer. Alternatively, the name of the company can be manually entered in the box. The next item of information to be entered is the topic discussed. This is accomplished by the physician manually entering the topic on the line next to the word “Topic.” In this example, the topic entered is “Management hypertension.” The next item of information collected is the quality of the discussion/presentation on the topic. This is accomplished by clicking on the drop-down list or pick-list arrowhead next to the words “Topic Quality.” In the example shown the physician has selected a numerical value of “6” (see Table 2, above, for the various entries that can be selected for this metric). The next item of information collected is the location of the meeting or event. This is accomplished by clicking on the drop-down list or pick-list arrowhead next to the words “Location.” In the example shown the physician has selected “restaurant” (see Table 2, above, for the various entries that can be selected for this metric). The next item of information collected is the quality of the location. This is accomplished by clicking on the drop-down list or pick-list arrowhead next to the words “Location Quality.” In the example shown the physician has selected “Very Good” (see Table 2, above, for the various entries that can be selected for this metric). The next item of information collected is the identity of the pharmaceutical company product discussed or promoted at the event. This is accomplished by selecting the appropriate drug from the pick list in box located next to the word “Product.” In the example shown the physician has selected “NORVASC” (see Table 2, above, for the various entries that can be selected for this metric). The next item of information collected is the nature of the discussion or promotion with respect to the selected drug. This is accomplished by selecting the entry from the pick list in box located next to the word “Nature.” In the example shown the physician has selected “product specific” (see Table 2, above, for the various entries that can be selected for this metric). The next item of information collected is the length of the program. This is accomplished by selecting the entry from the pick list located next to the words “Program Length.” In the example shown the physician has selected “1-2 hours” (see Table 2, above, for the various entries that can be selected for this metric).

That last selection ends the data being captured by the first screen of the meetings and events module. To go to the next screen, shown as the right-most screen in FIG. 7, the physician clicks on the “Next” button on the bottom of the first meetings and events screen. When the second screen opens, the physician can enter the identity of the speaker in the lines appearing next to the word “Speaker.” In this example the physician entered the name “Dr. Smith.” The next item of information collected is information about the speaker, e.g., Dr. Smith. This is accomplished by selecting the entry from the pick list located next to the words “Speaker Info.” In the example shown the physician has selected “local specialist” (see Table 2, above, for the various entries that can be selected for this metric). The next item of information collected is information about the number of attendees. This is accomplished by manually entering a number on the line located next to the words “Attendee Count.” In the example shown the physician has enter “10” (see Table 2, above, for the various values that can be selected for this metric). The last item of information collected is if CME (Continuing Medical Education) credits are given for this meeting or event. This is accomplished by checking the box located next to the words “CME Credits Offered” if the attendance at the meeting or event warrants such credits. The completion of the collection of meeting and event data is achieved by clicking on the button marked “Done” at the bottom of the second screen.

As mentioned above, physicians also capture diagnosis and treatment data for use by the system 20 to be correlated to the sales and promotional activities of the pharmaceutical company reps. The diagnosis and treatment information is entered by the physician into the laptop computer at the time that the physician is working on the particular patient's chart. At this time the physician enters in all of the data regarding the diagnosis and treatment of the patient, e.g., what drugs the physician prescribed, how that prescription will be delivered to the patient (e.g., by samples, by the filling of the prescription by a pharmacy or by a combination of the two). The treatment information collected not only includes the identity of the drug, but the form strength level of the drug prescribed. The physician also collects information regarding if there was a drug switch, e.g., was the patient switched from one drug to another and if so, from what to what. The physician also collects as part of the diagnosis and treatment data, some data heretofore not collected, namely, if the patient suggested a particular drug that he/she may have seen advertised or heard about.

The details of the type and manner of collection of the diagnosis and treatment data will now be described with reference to FIG. 8 which shows screens of the physician's laptop computer for entering the relevant data. As mentioned earlier, this information can also be entered into the PDA. In either case the diagnosis and treatment information is entered by the physician at the time that he/she enters information into the patient's chart. This data is collected and entered two days per week by the physicians of the panel, so roughly 40% of the total number of patients seen by each physician of the panel can be correlated to the sales and promotional activities of the pharmaceutical company reps by the analysis of the data in the system.

As can be seen the first item of information to be entered is the date of the patient's visit to the physician. This is entered automatically by the lap-top's internal clock and is displayed on the lap-top's screen in the box under the words “Date of Visit,” unless the patient's visit did not occur on that date. If that is the case the physician enters the actual date of the visit (as defined in Table 3 above). The physician next enters data regarding the patient's age, gender and race in the boxes under the words “Age,” “Gender” and “Race,” respectively. The values/entries that can be placed in these boxes are shown in Table 3. In the example shown, the patient is a 61 year old, male Asian. The physician next enters data regarding the patient's insurance, if any. This is accomplished by clicking on the downward pointing arrow for the box under to the word “Insurance” on the screen, whereupon a drop down or pick list of the entries or values for this category is displayed (see Table 3, above, for the various entries that can be selected). The physician clicks on 20 the appropriate entry and that now appears in the box. In this example, the data “HMO/PPO/POS” has been selected. The next item of information to be entered is the location of the patient visit, e.g., whether in the office, in a clinic, in a hospital, etc. This is accomplished by clicking on the downward pointing arrow for the box under to the word “Location” on the screen, whereupon a drop down or pick list of the entries or values for this category is displayed (see Table 3, above, for the various entries that can be selected). The physician clicks on the appropriate entry and that now appears in the box. In this example, the word “Office” has been selected.

The system of this invention enables the physician to enter data for up to three diagnoses in the system. These three diagnoses are identified by the tabs on the lap-top screen bearing the words “Diagnosis 1,” “Diagnosis 2” and “Diagnosis 3.” To enter data for the first diagnosis the physician clicks on the Diagnosis 1 tab, whereupon his/her laptop screen looks like FIG. 8. The physician can then enter information about this first diagnosis. To that end, the first item of information to be entered is the ICD-9 code for the diagnosis. This is accomplished by clicking on the left-most box under Diagnosis 1 tab, whereupon a drop down or pick list of the entries or values for this category is displayed (see Table 3, above, for the various entries that can be selected). The physician clicks on the appropriate entry and that now appears in the box. In this example, the code “401” has been selected. Upon the entry of this code, the words “essential hypertension” which is the diagnosis represented by code 401 appears in the box to the right of the box bearing the code. This entry is automatically provided by the system. Alternatively, the physician can enter the words “essential hypertension” into that box, by selecting it from the pick-list for that box (see Table 3, above, for the various entries that can be selected), whereupon the system 20 will cause the ICD-9 code “401” to appear in the right-most box. The next item of information to be entered is the diagnosis type, i.e., whether the diagnosis is new or previously diagnosed. This data is entered into the appropriate check box next to one of the words “Newly diagnosed” and “Prev Diagnosed.” In this example the box “Prev Diagnosed” has been selected. The next item of information to be entered is the severity of the diagnosed condition, i.e., whether mild, moderate or sever. This data is entered into the appropriate check boxes next to the words “Mild,” “Moderate” and “Severe.” In this example the box “Moderate” has been selected. The next item of information to be entered is the type of non-drug treatment given by the physician. This data is entered into the appropriate check box(s) next to the words “Diet,” “Exercise,” “Rest,” “Other” and “Alternative.” In this example the boxes “Diet” and “Exercise” have been selected.

The next item of information to be entered is if the patient requested a drug by name. This data is entered into the box under to the words “Did The patient Request Drug By Name?” from the choices yes (“Y”) or no (“N”). In this example, yes (“Y”) was selected. The next item of information to be entered is the name of the drug requested. This is accomplished by clicking on the downward pointing arrow for the box next to the words “Drug Request” on the screen, whereupon a drop down or pick list of all of the drugs tracked by the system 20 appears. The physician clicks on the appropriate entry and that now appears in the box. In this example, the drug “COZAAR” has been selected and appears in that box.

The system of this invention also enables the physician to enter data for up to three prescriptions intended for the diagnosis selected. These three prescriptions are identified by the tabs on the Diagnosis 1 screen of the lap-top computer bearing the words “Rx 1 Diagnosis 1,” “Rx 2 Diagnosis 1” and “Rx 3 Diagnosis 1.” To enter data for the first diagnosis the physician clicks on the Rx 1 Diagnosis 1 tab, whereupon his/her lap-top screen looks like FIG. 8. The physician can then enter information about the first prescription for that diagnosis. The first item of information to be entered for that prescription is the name of the drug requested. This is accomplished by clicking on the downward pointing arrow for the box under to the words “Product Name” on the screen, whereupon a drop down or pick list of all of the drugs tracked by the system 20 appears. The physician clicks on the appropriate entry and that now appears in the box. In this example, the drug “LIPITOR” has been selected and appears in that box. The next item of information to be entered for that prescription is the form strength of the drug requested. This is accomplished by clicking on the downward pointing arrow for the box under to the words “Form/Strength” on the screen, whereupon a drop down or pick list of all the form/strength for that particular drug appears. The physician clicks on the appropriate entry and that now appears in the box. In this example, the drug “40 MG TABLET” has been selected and appears in that box. The next item of information to be entered is how the prescription is to be provided to the patient, i.e., whether by prescription (Rx), a prescription with samples, or by samples only. This data is entered into the appropriate check boxes next to the words “Rx,” “Rx with Samples” and “Sample Only.” In this example the box “Rx with Samples” has been selected. The next item of information to be entered for that prescription is the amount to be dispensed. The number of doses is entered into the box next to the word “Dispensed.” In this example the number 20 has been entered. The next item of information to be entered for that prescription is the schedule for the taking of the drug by the patient. This is accomplished by clicking on the downward pointing arrow for the box under to the words “Schedule” on the screen, whereupon a drop down or pick list of the various schedule times appears (see Table 3, above, for the various entries that can be selected). The physician clicks on the appropriate entry and that now appears in the box. In this example, the frequency of “BID” has been selected and appears in that box. The next item of information to be entered for that prescription is the number of days of therapy for the samples. This number is entered into the box next to the words “Days of Therapy for Samples.” In this case the amount entered is 14.

The next item of information to be entered for that prescription is if the physician switched the prescription from a previous different product. If so the physician enters the name of the previous prescription drug in the box appearing next to the words “Previous Product Name.” The name of the previous prescription is selected from the drop down list of all of the drugs tracked by the system 20. The physician clicks on the appropriate entry and that now appears in the box. In this example, the drug “ZOCOR” has been selected and appears in that box. If there was a drug switch, the physician now enters the reason for the switch in the box next to the words “Why Switch.” In this case the physician has entered “not achieving desired LDL and HDL levels in plasma” as the reason for the switch.

The physician can then enter data about a second and third diagnosis in the same manner. Once all of the data has been entered, the physician clicks on the “Add” (in the case where the data is entered into the laptop) or “Done” (in the case where the data is entered into the PDA) button at the bottom of the screen to enter all of that data in the patient's file for subsequent uploading to the system server.

As should be appreciated from the foregoing, by collecting the information from the physicians who are actually doing the prescribing, as accomplished by the system of this invention, a much more accurate picture is developed regarding the effectiveness of the pharmaceutical companies detailing than had heretofore been possible by merely looking at prescription that are dispensed from various pharmacies. In this regard, the prior art techniques of using a collection of data from large national or regional pharmacies regarding dispensed drugs does not reveal the true causal connection picture. In this regard, the drugs that are actually dispensed by the pharmacy may not be the drugs that the physicians prescribed. For example, a generic drug may be substituted by the pharmacy, a health maintenance organization or other insurer may require that a different drug be given, etc. Thus, the collection of data regarding what drugs were ultimately dispensed to the patient does not indicate the correlation between what the physician intended the patient to get and what the patient actually gets.

As will be described shortly, the system of the subject invention provides an output metric of the “intended prescription” that is the prescription actually given by the treating physician, in response to being confronted by the various reps of the various pharmaceutical companies. This metric presents a highly accurate picture of the effectiveness of the pharmaceutical company's detailing and represents the benchmark metric for gauging the effectiveness of a pharmaceutical company's detailing process. Thus, by utilizing a single universe of physicians collecting the promotion data as well as the diagnosis treatment and intended prescription data, the subject system can provide a very accurate picture of the cause and effect of a pharmaceutical company's detailing procedures.

The output data provided by the system, i.e., the data representative of the analyzed input data, is provided primarily in electronic form to the pharmaceutical company clients of the system provider. That output data includes various unique metrics that quantify aspects of the promotional activities of the sales reps. The first metric to be discussed and referred to generically as “Metric No. 1,” is a grade provided to the companies with regard to their sales reps' ability to gain access to the physician office. In an embodiment of this invention provided by the assignee of this invention, Metric No. 1 is designated by the trademark “ACCESS RATING” and represents the percentage of time that the sales reps are successful in getting past the front desk and are in a position to see the targeted physician face-to-face. The second metric, designated as Metric No. 2, grades the companies with regard to their sales reps' ability to encounter the physician face-to-face. Metric No. 2 is designated by the assignee of this invention by the trademark ENCOUNTER RATING and represents the percentage of time the sales reps are successful in getting past the front desk of the physician's office to be able to see the targeted physician face-to-face.

Among the data analyzed to produce the aforementioned metrics, the database of the system 20 keeps track in the database of the total office visits, i.e., the sum total of all sales rep visits to the physician office as recorded by the designated office staff personnel. The sum total of all sales reps that gain access to the physicians (as also recorded by the designated office staff) are also collected and included in the database as the “Total Office Access Counts.” The sum total of all sales reps' face-to-face engagements with the physicians (as also recorded by the designated office staff personnel) is also collected and included in the database as the “Total Physician Encounters.”

As discussed earlier, the system collects four different types of sales rep-physician engagements. These engagements are referred to as the “encounter type” and consist of the following: “no product discussed,” “one way discussion,” two way discussion,” and “meeting and event.” As also discussed, if the sales rep had a face-to-face discussion with the physician but no product was discussed, this “No Product Discussed” data is recorded by the physician and collected for the database. A one way discussion comprises a face-to-face discussion that results only in the sales reps speaking. A two way discussion is a face-to-face discussion that results with both the sales rep and the physician engaged in a product discussion.

From the foregoing data, Metric No. 1 (the ACCESS METRIC) is calculated by taking the total office access counts and dividing that by the total office visits. Metric No. 2 (the ENCOUNTER RATING metric), is calculated by taking the total physician encounters and dividing that by the total office visits.

The system of the subject invention provides one other unique metric, designated as Metric No. 3. The Metric No. 3 grades companies in relation to the number of intended prescriptions generated from a single sales rep-physician encounter and is designated by the trademark “PROMO RATING” by the assignee of this invention. To calculate Metric No. 3 data is collected regarding all prescriptions written by the physician for specific product/company combination. This data is designated by the trademark “INTENDED PRESCRIPTION” or“IRx” by the assignee of the subject invention. The PROMO RATING metric of any particular product is calculated by taking the new or total IRx metric and dividing it by the total product discussions. The PROMO RATING metric of any particular company is calculated by taking the new or total IRx metric and dividing it by the total company encounters.

The report output of the subject invention also includes a measure of the frequency of product level encounters in conjunction with subsequent physician prescribing patterns. This report (sales representative activity optimization) is provided to the company clients and is based on various data collected and analyzed. That data includes the sum total of all sales rep' face-to-face engagements with the physician (the “Total Physician Encounter”). In addition, the sum total of all prescriptions written for a specific product on an individual patient-diagnosis basis is collected and used in the database and is referred to as the “Total Intended Prescription.” The data also collected includes the sum total of all product specific prescriptions written for the first time on an individual patient-diagnosis basis. This is referred to as the “New Intended Prescription.” In addition, the sum total of all product specific prescriptions written for at least the second time on an individual patient-diagnosis basis is collected and provided in the database. This is referred to as the “Renewal Intended Prescription.” Further still, the sum total of all product specific prescriptions written for the first time, where a previous product therapy existed on an individual patient-diagnosis basis, is also collected and provided in the database. This is referred to as the “Switch Intended Prescription.” Lastly, the database includes the percentage of physicians engaged in a defined number of encounters within a given time frame. This is referred to as the “Percentage Of Physicians Linked To Encounters.”

Another report provided by the subject invention is the “Drug Mention Impact Report.” This report measures the effect of product-level patient drug mentions (DTC generated) impact on physician product prescribing. This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, and the sum total of all product specific prescriptions written for the first time where a previous product therapy existed on an individual patient-diagnosis basis.

Another report provided by the subject invention is the “Diagnosis/Drug Mention Impact Report.” This report measures the effect of product-level patient drug mentions (DTC generated) impact on the physician product prescribing within a given diagnosis. This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual diagnosis basis, the sum total of all product specific prescriptions written for the first time where a previous product therapy existed on an individual patient-diagnosis basis, and the sum total of patient visits for a particular diagnosis.

Another report provided by the system is the “Sales Rep Encounter Type Distribution Report.” This report details the product level mix of sales rep-physician encounters. The product-level encounter types are one-way discussions, two-way discussions and meeting and events. This report is based on the sum total of all sales rep face-to-face engagements with the physicians, the encounter types (whether one-way discussions, two-way discussions or meeting and events).

Another report provided by the system measures the frequencies of sales rep product level encounters in relation to specific product discussion order slots. This report is based on data regarding the product that was discussed as the first detail within an encounter (called the product priority No. 1 encounter), the product that was discussed as the second detail within the encounter (referred to as the product priority No. 2 encounter), and so on.

Another report provided by the subject invention is the “Meeting and Event Time Distribution Report” which details the product level mix of physician attended meetings and events in relation to the length of time for each program. This report is based on data regarding the total time spent by the physician at each individual attended meeting and event. As discussed earlier, these times are recorded by the physician as one of the following: less than 30 minutes, 31 minutes to one hour, one to two hours, two to four hours, greater than four hours and overnight.

Another report provided by the system is the product intended prescription distribution report (referred to as the “Product Distribution Report”). This report details the measurement of the product level physician prescribing (new, renewal or switch) within a defined competitive matrix. This report is based on the sum total of all prescriptions written for specific product on an individual patient-diagnosis basis, the sum total of all product specific prescriptions written for the first time on an individual patient-diagnosis basis, the sum total of all product specific prescriptions written for at least the second time on an individual patient-diagnosis basis and the sum total of all product specific prescriptions written for the first time where a previous product therapy existed on an individual patient-diagnosis basis.

Another report provided by the subject system details individual product-product prescribing patterns at an individual diagnosis level. This report is known as the “Concomitant Product Intended Prescription Distribution Report.” Individual product information is provided for when the product is used alone and in combination with other products for a single diagnosis. This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, the sum total of all product specific prescriptions written for the first time where a previous product therapy existed on an individual patient-diagnosis basis and whether the prescribed product will use alone for indicated diagnosis (referred to as product used alone) or whether the prescribed product was used in conjunction with another product for the indicated diagnosis (referred to as the concomitant products).

Another report provided by the system details the competitive product level mix of prescriptions within individual diagnoses and is referred to as the “Diagnosis/Product Intended Prescription Distribution Report.” This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, and the sum total of all product specific prescriptions written for the first time where a previous product therapy existed on an individual patient-diagnosis basis.

Another report provided by the system of this invention details the competitive product level mix prescriptions within individual, new and previous diagnosis types. This report is referred to as the “Diagnosis Type/Product Intended Prescription Distribution Report.” This report is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, the sum total of all product specific prescriptions written for the first time where a previous product therapy existed on an individual patient-diagnosis basis, the diagnosis being treated by the physician for the first time (referred to as the newly diagnosed), and the diagnosis for which the individual patient has been previously treated (referred to as the previously diagnosed).

Another report provided by the system of this invention details the intended prescription distribution for a product by diagnosis. This report is referred to as the “Product/Diagnosis Report” and is based on the sum total of all prescriptions written for a specific product on an individual patient-diagnosis basis, the sum total of all product specific prescriptions written for the first time on an individual patient-diagnosis basis, the sum total of all product specific prescriptions written for at least the second time on an individual patient-diagnosis basis, and the sum total of all product specific prescriptions written for the first time where a previous product therapy existed on an individual patient-diagnosis basis.

The foregoing reports are merely exemplary of many variations of reports that can be produced in accordance with the teachings of the invention. For example, an output report may include a measure of what can be called the “Physician Promotion Response,” that is the response of the physician (as measured by the IRx metric) to promotion (in the form of pharmaceutical rep activity).

It should be pointed out at this juncture that the system and method described heretofore to provide what can be referred to a “linked core information” is merely exemplary and many variations can be made to them within the scope of this invention. For example, it is contemplated that the system and method can be used to link core information with pharmaceutical company call file record information. In particular, the linked core information could be linked at an individual pharmaceutical company level to that company's call files. As is known, the call file is a self-reported record kept by the sales representatives of physician encounters or details. Linking the linked core information produced by the subject invention and as described above with the collected information of the company call file will enable comparative analysis' of encounter activity. Specifically, such a system will provide the ability to discern true call activity and the delta between self-reported call activity and physician reported encounter activity.

It is also contemplated to link the linked core information produced by the subject invention with pharmaceutical company sample file record information. In particular, the linked core information could be linked at an individual pharmaceutical company level to that company's sample files. As is known the sample file is a FDA-mandated reporting record of product samples provided to individual physicians. Linking the linked core information to the company sample file will enable comparative analysis' of sales representative office-level activity. Specifically, such a system will provide the ability to discern true office activity levels and the difference between sample activity and physician office staff reported office activity.

It is also contemplated to link the linked core information produced by the subject invention with pharmacy-level dispensed product prescription information. In particular, the core claim information could be linked at an individual pharmaceutical company level to that company's respective dispensed product information. Pharmacy-level dispensed product information would be provided by a third-party vendor (e.g., IMS Health or NDC Health, Inc. of Atlanta, Ga.). Linking the linked core information to the dispensed product prescription information will enable comparative analysis' of the delta between physician intended and pharmacy dispensed product prescription information.

It is also contemplated to link the linked core information produced by the subject invention with patient-level disease treatment and managed care organization (M.O.) information. In particular, the linked core information could be linked at an individual pharmaceutical company level to specific patient disease treatment and M.O. product information. Both the patient disease treatment and M.O.-level information would be provided by a third-party vendor. Linking the linked core information to both the patient disease treatment and M.O. information will enable comparative analysis of the entire Patient-Provider-M.O. disease treatment continuum.

As should be appreciated from the foregoing the subject invention focuses on a specific universe of physicians, and it only uses that one universe for the collection of both marketing data and disease and treatment data. That universe comprises primary care, high-volume prescribing physicians (e.g., general practitioners, but may comprise other physician specialties, as well). This is a subset of the general universe of physicians that have been used in the past for each of the two panels. Moreover, and quite significant, It is these primary care, high-volume prescribing physicians that the pharmaceutical industry targets for its promotional activities. Thus, by collecting the promotional and diagnosis and treatment information from this one panel of physicians, the subject invention enables one to accurately assess the correlation between the promotional activities of the reps and the diagnosis and treatment provided to the patients. Thus, the system of the subject invention provides much more accurate and relevant information to the pharmaceutical companies.

Without further elaboration the foregoing will so fully illustrate our invention that others may, by applying current or future knowledge, adopt the same for use under various conditions of service.

We claim:

1. A method for evaluating any causal linkage between the promotional activities of sales representatives for specific pharmaceuticals of various pharmaceutical companies and the pharmaceuticals prescribed by physicians for their patients, said method comprising:
(A) establishing a single panel of a plurality of geographically diversified prescribing physicians;
(B) collecting first data from each of said physicians regarding the promotional activities of the sales representatives whom said physicians have encountered with respect to the specific pharmaceuticals;
(C) collecting second data from each of said physicians regarding the diagnosis and treatment of the patients of said physicians with respect to said specific pharmaceuticals;
(D) providing said first and second data into a database; and
(E) analyzing said database of said first and second data to evaluate any cause and effect relationship between the promotional activities of the sales representatives and the pharmaceuticals prescribed by the physicians to their patients.

2. The method of claim 1 wherein said physicians are general practitioners, family practice practitioners and internal medicine practitioners.

3. The method of claim 1 additionally comprising:
(F) collecting third data regarding the access of said sales representatives to each of said physicians, and providing such access information into said database.

4. The method of claim 3 wherein said method additionally comprises:
(G) analyzing said database to quantify the percentage of representatives for a specific pharmaceuticals who gain access to said physicians.

5. The method of claim 1 wherein said first data from each of said physicians comprises data regarding the sales representative's encounter with that physician, and wherein said method additionally comprises:
(F) analyzing said database to quantify the percentage of sales representatives for the specific pharmaceuticals who encounter said physicians.

6. The method of claim 5 wherein said first data also includes information regarding the nature of the encounter.

7. The method of claim 6 wherein said data about the nature of the encounter indicates if the encounter was a one-way conversation, a two-way conversation or a combination of a one-way and two-way conversation about a specific pharmaceutical or plural specific pharmaceuticals, or if the encounter did not include any reference to any specific pharmaceutical(s).

8. The method of claim 6 wherein said data about the nature of the encounter indicates whether a specific message about the pharmaceutical that is intended to be delivered by the sales representatives to the physician was, in fact, delivered to the physician.

9. The method of claim 7 wherein said data about the nature of the encounter also indicates whether a specific message about the pharmaceutical that is intended to be delivered by the sales representatives to the physician was, in fact, delivered to the physician.

10. The method of claim 1 wherein said database is provided with reference data including information regarding said specific pharmaceuticals, and which reference data is updated so as to be current.

11. The method of claim 1 wherein said database is provided with data regarding said physicians of said panel.

12. The method of claim 1 additionally comprising:
(F) utilizing hard-copy forms for collecting data regarding the access of said sales representatives to each of said physicians, and for providing such access data into said database.

13. The method of claim 1 wherein said first and second data is captured by said physicians on data entry devices selected from the group consisting of personal computers and personal digital assistants.

14. The method of claim 13 wherein said first and second data is provided electronically from said data entry devices via an electronic communication network to said database.

15. The method of claim 14 wherein said electronic communication network comprises the Internet.

16. The method of claim 1 wherein said method comprises making use computerized means for establishing said database and wherein said method additionally comprises utilizing said computerized means for:
(F) pre-processing said data into a loadable format;
(G) loading said data into first database tables;
(H) transforming field values into standard dimensional values;
(I) loading transformed records into second database tables;
(J) extracting transaction records into detailed fact tables;
(K) creating summary tables from detailed fact tables; and
(L) extracting fact and dimensional tables for data output.

17. The method of claim 13 wherein said first and second data is provided from said data entry devices via the Internet to said database and wherein the method additionally comprises utilizing hard-copy forms for collecting data regarding the access of said sales representatives to each of said physicians and providing said access data in electronic form to said database.

18. The method of claim 17 wherein said access data is provided by facsimile for inclusion in said database, wherein said method comprises making use computerized means for establishing and managing said database and wherein said method additionally comprises utilizing said computerized means for:
(F) pre-processing said data from said data entry devices and from facsimile to render said data into a loadable format;
(G) loading said data into first database tables;
(H) transforming field values into standard dimensional values;
(I) loading transformed records into second database tables;
(J) extracting transaction records into detailed fact tables;
(K) creating summary tables from detailed fact tables; and
(L) extracting fact and dimensional tables for data output.

19. The method of claim 1 additionally comprising collecting data representing the pharmaceutical company call record information and providing such call record data into said database to discern true call activity and the correlation between self-reported call activity and physician reported encounter activity.

20. The method of claim 1 additionally comprising collecting data from the physician office staff regarding access of the sales representative to the physicians, and also collecting data representing pharmaceutical company sample file record information and providing such sample file record data into said database to discern true physician office activity levels and the correlation between sample activity and physician office staff reported office activity.

21. The method of claim 1 additionally comprising collecting data representing pharmacy-level dispensed product prescription information and providing said pharmacy-level dispensed product prescription data into said database to provide a comparative analysis of the correlation between physician intended and pharmacy dispensed product prescription information.

22. The method of claim 1 additionally comprising collecting data representing patient-level disease treatment and managed care organization (M.O.) information and providing such patient-level disease treatment and managed care organization data into said database to provide a comparative analysis of the entire patient-provider-M.O. disease treatment continuum.

23. A system for evaluating any causal linkage between the promotional activities of sales representatives for specific pharmaceuticals of the various pharmaceutical companies and the pharmaceuticals prescribed by physicians for their patients, said system comprising a plurality of data entry devices, a electronic communications network and a computerized database, said plural data entry devices being arranged for use by a single panel of plural, geographically diverse prescribing physicians to collect first and second data from each of the physicians, said first data comprising information about the promotional activities of the sales representatives whom the physicians have encountered with respect to specific pharmaceuticals, said second data comprising information about the diagnosis and treatment of the patients of the physicians with respect to the specific pharmaceuticals, each of said data collection devices being arranged to be coupled to said electronic communications network to provide said data to said computerized database, said computerized database being arranged to be analyzed with respect to said first and second data to evaluate any cause and effect relationship between the promotional activities of the sales representatives and the pharmaceuticals prescribed by the physicians to their patients.

24. The system of claim 23 wherein said data entry devices are selected from the group consisting of personal computers and personal digital assistants.

25. The system of claim 23 wherein said electronic communication network comprises the Internet.

26. The system of claim 25 wherein said system is arranged to provide output data to any companies of the pharmaceutical industry regard the pharmaceuticals of their company and its competitors.

27. The system of claim 26 wherein said output data is in the form of a hard-copy report.

28. The system of claim 26 wherein said output data comprises client data extracts.

29. The system of claim 28 wherein said client data extracts are provided in hard-copy form.

30. The system of claim 26 wherein said output data is in electronic form.

31. The system of claim 30 additionally comprises a front end tool for enabling users of said front end tool for extracting selected information from said output data.

32. The system of claim 23 wherein said database is also provided with data regarding the access of the sales representatives to each of the physicians.

33. The system of claim 32 wherein system includes hard-copy forms for collecting said data regarding access of the sales representatives to each of the physicians.

34. The system of claim 33 wherein said system includes means for converting the data in said hard-copy forms to electronic signals for use in said computerized database.
